(19) United States
(12) Patent Application Publication
(10) Pub. No.: US 2010/0128005 A1
(43) Pub. Date: May 27, 2010

(54) TOUCH PANEL BY OPTICS UNIT SENSOR

(75) Inventors: Yang Rae Kim, Incheon (KR); Chang II Han, Goyang-city (KR)

Correspondence Address: Jae Y. Park, Kile, Goekjian, Reed & McManus, PLLC, 1200 New Hampshire Ave. NW, Suite 570, Washington, DC, 20036, US

(73) Assignee: TOVIS CO., LTD., Wonju-city, Gangwon-do (KR)

(21) Appl. No.: 12/593,540

(22) PCT Filed: Apr. 4, 2007
(86) PCT No.: PCT/KR2007/001651

§ 371 Date: Sep. 28, 2009

(30) Foreign Application Priority Data
Mar. 29, 2007 (KR) 10-2007-0030980

(51) Int. Cl. G06F 3/042

(52) U.S. Cl. 345/175

(57) ABSTRACT

There is provided the touch panel by optics unit sensor that realizes one system of touch panel in all view angles, that is, from a small touch region to a large touch region, prevents a scratch from affecting on the surface of the display panel forming the touch region, enables the uniform sensing operation, and an accurate calculation of the touch distance and improves the response speed. The touch panel is designed, without the coating layer for conduction which is needed in each conventional touch panel, and has high durability, high optical transmittance and high resolution.

### TECHNICAL FIELD

The present invention relates to a touch panel using an optical sensor unit.

### BACKGROUND ART

Diverse input devices, such as a personal computer, a portable transmitter, a digitizer and the like, are used to outwardly display text, graphics and the like through a display panel (LCD or the like).

As an example of the aforementioned input device, a touch panel is well known and the touch panel has been developed from an input device such as keyboard or the like through which a data processing is processed. When using the touch panel, input is easily performed by directly touching a display panel with reducing malfunction and inputting characters without any other input tools.

A detection type, structure and performance by the aforementioned touch panel are well known in detail. For example, the types of the touch panel include a resistive type in which two resistive element sheets are arranged to be spaced apart from each other by a spacer and to be contact with each other by press, a capacitive type, an ultrasonic wave input type, an infrared input type, an electromagnetic inductive type, and others.

Among the aforementioned touch panel types, the resistive type is most used as the input machinery and tools, such as an electronic scheduler, a PDA, a portable PC and the like, and is known as being advantageously designed to be thin in thickness, small in size, light in weight or low in power consumption, compared with the other types. The resistive type has the structure in that two substrates coated with a transparent electrode layer (for example, ITO) are connected to face each other, with a dot spacer interposed between the two substrates. The resistive type has the operation principle that, when a finger or a pen touches the upper substrate, a signal of position detection is applied and when the finger or the pen touches the transparent electrode layer of the lower substrate, the electrical signal is detected to determine the position. This resistive type has high response speed and high economical efficiency but it has low durability and is likely to be easily damaged.

In the capacitive type, both surfaces of a substrate forming a touch screen sensor are coated with a special conductive metal material (for example, TAO: tin antimony oxide) to form a transparent electrode. A predetermined amount of a current is allowed to flow on the glass surface. The capacitive type has the operation principle that, when a user touches the capacitive type, detects the position through sensing the part where the amount of the current is changed by using the capacitance of the human body through parasitic capacitance and calculating the size thereof. However, since this capacitive type uses the capacitance of the human body, it is difficult to be operated by a pen or hands with gloves. Moreover, since this capacitive type is likely to be affected by external environments, it is difficult to design its structure and circuit, so it has limitations in use. Moreover, when manufacturing a large-size display panel product, there are considerable difficulties. Moreover, this capacitive type is weak to scratches on the glass surface.

In the ultrasonic wave type, a piezoelectric element applying a pressing effect is used. In this type, when the panel is touched, surface waves are allowed to be generated in X and Y directions alternately and the distances from the respective directions to each input point are sensed to determine the position. This ultrasonic wave type has high resolution and optical transmittance. However, the sensor is likely to be contaminated and the touch panel is weak to a liquid.

In the infrared type, a number of light-emitting elements and a number of light-receiving elements are arranged about the panel to form a matrix. When a light beam is interrupted by a user, X and Y coordinates of an output point which is a decreased part where the light beam is interrupted is obtained to judge input coordinates. In this infrared type, since no overlay is used, the optical transmittance is high and the durability to external impacts or scratches is strong. However, in a bulky monitor using infrared rays, a sensibility to a touch is lowered and the response speed is also slow.

As described, each type of the aforementioned touch panels has its own features and drawbacks. However, since each type of the touch panel is selected according to the size of a touch region, the touch panel is restrictively realized. That is, each touch panel needs to be manufactured by each use-purpose and each applicable technology is limited to its touch panel type, making it difficult to constitute the same system.

### DISCLOSURE OF INVENTION

### Technical Problem

Therefore, the present invention has been made to solve the above problems, and it is an aspect of the present invention to realize one system of touch panel in all view angles that is, from a small touch region to a large touch region, thereby making manufacturing easy.

It is another aspect of the present invention to provide a touch panel which prevents a scratch from affecting on the surface of a display panel forming a touch region, which is capable of a uniform sensing operation and an accurate calculation of a touched distance and which improves a response speed.

It is another aspect of the present invention to provide a touch panel which is designed without a coating layer for conduction which is needed in a conventional method for realizing each touch panel and which has high durability, high optical transmittance and high resolution.

### Technical Solution

The present invention to accomplish the above and other aspects provides a touch panel having a response structure using an optical sensor unit, in which an indicative part being indicated toward a display panel is photographed by the optical sensor unit, a coordinate value is obtained by reading an image being photographed, an indicative position of the display panel is detected by analyzing and measuring the coordinate value, corresponding indicative data is input, and information is read based on the corresponding indicative data being input, to display the corresponding informat ion through the display panel.

### Advantageous Effects

In accordance with the present invention, the touch panel is realized irrespective of the size of a display panel, that is, irrespective of a small, medium or large display panel. Further, the glass surface does not need to be coated with the conductive material or the like. Therefore, the process of manufacturing the touch panel is simplified and the production costs are reduced.

Furthermore, the touch panel according to the present invention comprises one optical sensor unit or a number of individual optical sensors. Therefore, since a number of sensing processes are performed within one display panel, a number of operations can be performed simultaneously.

Furthermore, since the touch panel according to the present invention is not directly affected by external contaminants, it minimizes the loss by malfunction. Further, the touch panel is capable of a linear sensing process and obtains the glass inherent maximum resolution and transmittance, without decreasing the characteristics of glass, to produce a display panel using glass with high durability and high resistance to scratches.

### BRIEF DESCRIPTION OF THE DRAWINGS

These and other aspects and advantages of the present invention will become apparent and more readily appreciated from the following description of the embodiments, taken in conjunction with the accompanying drawings, in which:

FIG. 1 is a block diagram of a response system using an optical sensor unit according to the present invention;

FIG. 2 is a block diagram of an output process when touching a display panel according to the present invention;

FIG. 3 is a schematic view of an example in the display panel according to the present invention; and

FIG. 4 is a block diagram of an example of an automatic touch position adjusting process of the optical sensor unit according to the present invention.

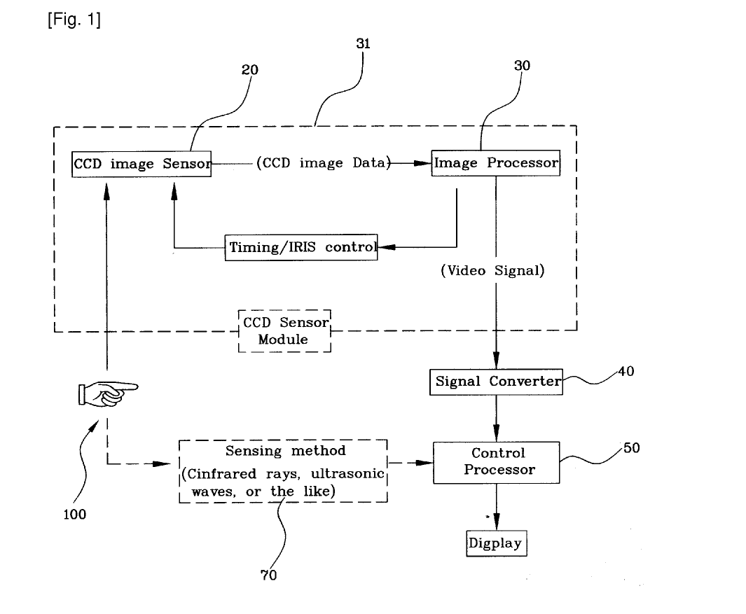

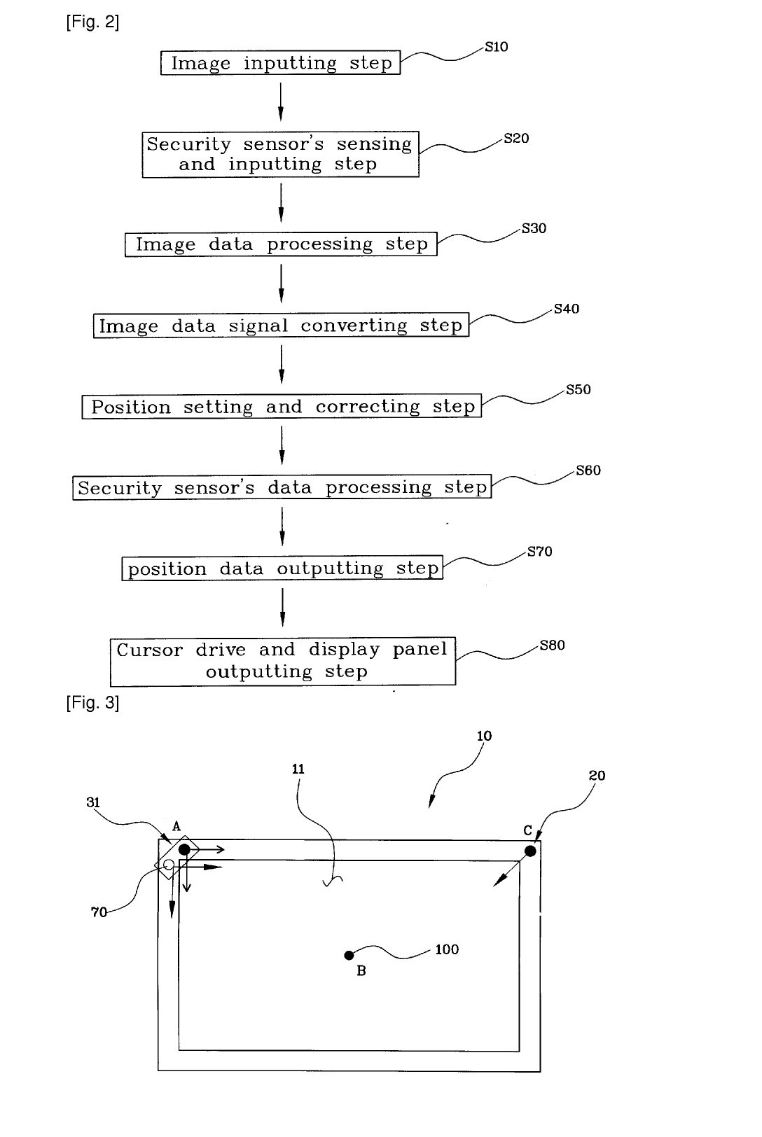

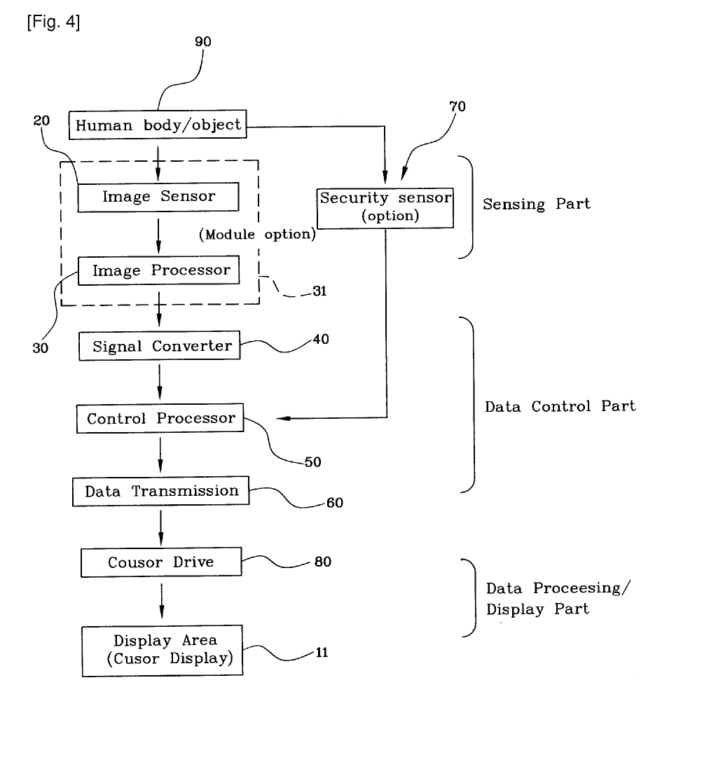

### BRIEF DESCRIPTION OF MAJOR REFERENCE NUMBERS IN DRAWINGS

10: display panel
11: touch panel region
20: individual optical sensor
30: image processor
31: optical sensor unit
40: signal converter
50: controller
60: data output/transmission unit
70: security sensor
80: cursor drive
90: human body or object
S10: input image
S20: input what is sensed by security sensor
S30: process image data
S40: convert image data signal
S50: set and correct position
S60: process sensed data of security sensor
S70: output position data
S80: drive cursor and output display

### BEST MODE FOR CARRYING OUT THE INVENTION

In accordance with an aspect of the present invention, there is provided a touch panel having a response structure using an optical sensor unit, comprising: an optical sensor unit or a number of individual optical sensors arranged around an edge part or on a diagonal line of a display panel detecting an image of human body or object approaching to a touch region of the display panel; an image processor obtaining an accurately focused image of the human body or object detected by the optical sensor unit or the number of individual optical sensors and outputting an image data signal; a controller converting the image data signal being output from the image processor into a digital signal and calculating a focus distance of the human body or object positioned in the touch region of the display panel; and a display output unit applying a communication value from the controller to a host and outputting a database of the host corresponding to the touch region, and wherein the one optical sensor unit or the number of individual optical sensors automatically calculate a position of the human body or object touching a specific point at a predetermined position displayed on the display panel, based on the database of the host, and automatically compensate the touch region of the display panel to automatically correct the touch region of the display panel.

In accordance with another aspect of the present invention, there is provided a touch panel having a response structure using an optical sensor unit, comprising: an image inputting step (S10) in which one optical sensor unit or a number of individual optical sensors arranged around an edge part or a diagonal line of a display panel inputs an image of a human body or object approaching to a touch region of the display panel; a security sensor's sensing and inputting step (S20) in which a security sensor, which is provided to correctly determine whether the human body or object approached to the touch region of the display panel have touched, senses and inputs whether touched or not to provide a sensed data; an image data processing step (S30) in which an image processor processes the image being input in the image inputting step (S10) and converts the image into an image data signal; an image data signal converting step (S40) in which the image data signal obtained in the image data processing step (S30) is converted into a digital signal recognizable for a controller and the digital signal is transmitted to the controller; a position setting and correcting step (S50) in which the controller calculates a focus distance of the human body or object positioned at the touch panel region of the display panel and corrects the position, based on the digital signal data sent from the image data signal converting step (S40); a security sensor's data processing step (S60) in which the sensed data is processed to distinguish whether the human body or object touches the touch panel region of the display panel, based on the sensing data being input in the security sensor's sensing and inputting step (S20); a position data outputting step (S70) in which a coordinate value calculated in the security sensor's data processing step (S60) and the position setting and correcting step (S50) is transmitted to a host such as PC or the like by communication; and a cursor driving and display panel outputting step (S80) in which the host receives the coordinate value being input in the position data outputting step (S70), loads a corresponding program, and displays data being processed by a database included in the program on the display panel.

### Mode for the Invention

Hereinafter, embodiments of the present invention will be described in detail with reference to the accompanying drawings.

The present invention is to realize a touch panel in which an object approaching to a touch panel region of a display panel is sensed by an optical sensor unit and a position of the object is tracked to display a corresponding program through the display panel.

To this end, a touch panel according to the present invention comprises: an optical sensor unit 31 or a number of individual optical sensors 20 at an edge part or on a diagonal line of a display panel 10.

In an embodiment of the present invention, the optical sensor unit 31 or individual optical sensors 20 use a CCD (charged-coupled device) image sensor or CMOS (complementary metal oxide semiconductor).

The display panel 10 applied to the present invention does not have the complicated structure of the display panel applied to a conventional touch panel. In the conventional touch panel, two substrates coated with a conductive material (for example: TAO: tin antimony oxide) or a transparent electrode layer (for example: ITO), interposing a dot spacer between the two substrates, connecting the two substrates to face the transparent electrode layers face each other and the like are configured.

In the present invention, the one optical sensor unit 31 or a number of the individual optical sensors 20 using the CCD image sensor or the CMOS image sensor are installed in the edge part or on the diagonal line of the display panel 10 such as an LCD, a PDP, an organic EL or the like without including any of the aforementioned constituent elements of the conventional touch panel.

When a user approaches to a touch panel region 11 of the display panel 10, the one optical sensor unit 31 or the number of individual optical sensors 20 photograph a human body or object 90 approaching to the one optical sensor unit 31 or the number of individual optical sensors 20 included in the display panel 20.

In the present invention, the touch panel region 11 means the touch region being displayed on the display panel 10.

After the one optical sensor unit 31 or the number of individual optical sensors 20 photograph the human body or object 90 approaching to the touch panel region 11, an image data of an image being accurately focused are obtained.

Obtaining the image accurately focused is like, for example, obtaining an accurate image of an object being photographed in a camera lens.

In step S10, an image of the human body or object 90 approaching to the touch panel region 11 of the display panel 10 is input. In step S20, undergoing a process of inputting the image of the human body or object 90 is preferable after sensing the human or object 90 by a separate security sensor 70 applied in the present invention to correctly determine whether the human body or object 90 approached to the touch panel region 11 of the display panel 10 have touched and to provide a sensed data.

That is, when the user approaches to the touch panel region 11 of the display panel 10 and if it is not distinguished for certain as to whether the human body or object 90 have touched, preferably, the separate security sensor 70 may be included for complement.

The security sensor 70 applied in the present invention may be constituted or applied in other types of a sensor which is capable of sensing the human body or object 90, for example, an infrared sensor, an ultrasonic wave sensor, a capacitive type sensor, a resistive type sensor, a piezoelectric type sensor and the like. The security sensor 70 controls to correctly determine whether the human body or object 90 touches.

In step S30, after the image obtained by the above steps is transmitted to an image processor 30, the image is output as an image data signal through the image processing.

In step S40, the image data signal being output by the image processor 30 is converted into a digital signal by a signal converter 40 recognizable for a controller 50. In step S50, the controller 50 calculates and corrects a focus distance of the human body or object 90 positioned in the touch panel region 11 of the display panel 10 based on the digital signal data being converted by the signal converter 40 to obtain an accurate coordinate value positioned in the touch panel region 11.

In step S60, it is preferably to correctly determine whether the human body or object 90 touches, based on the sensed data being obtained by the security sensor 70.

In step S70, the coordinate value being calculated through the position setting and correcting step S50 and the security sensor data processing step S60 is transmitted and outputted by a data output/transmission unit to a host such as PC and the like through the communication of the controller 50. In step 80, the host that receives the coordinate value loads software including a data base program of the corresponding touch panel region 11 by driving a cursor drive 80 or the like through the display panel 10, to display the corresponding program through the display panel 10.

In the present invention, the one optical sensor unit 31 or the number of individual optical sensors 20 automatically calculates the position of the human body or object 90 touching a specific point 100 at a predetermined position being displayed on the display panel 10 by the database of the host and compensates the position on the touch panel region 11 of the display panel 10, to realize the constitution for automatical compensation of the position.

### INDUSTRIAL APPLICABILITY

In accordance with the present invention, the touch panel by optics unit sensor realizes one system of touch panel in all view angles, that is, from a small touch region to a large touch region, prevents a scratch from affecting on the surface of the display panel forming the touch region, performs the uniform sensing operation, calculates the accurate touched distance and improves the response speed. The touch panel is designed without the coating layer for conduction which is needed in each conventional touch panel and has high durability, high optical transmittance and high resolution.

1. A touch panel by optics unit sensor, comprising:
an optical sensor unit or a number of individual optical sensors arranged around an edge part or on a diagonal line a display panel, detecting an image of human body or object approaching to a touch region of the display panel;
an image processor obtaining an accurately focused image of the human body or object detected by the optical sensor unit or the number of individual optical sensors and outputting an image data signal;
a controller converting the image data signal being output from the image processor into a digital signal and calculating a focus distance of the human body or object positioned in the touch region of the display panel; and
a display output unit applying a communication value from the controller and outputting a database of a host corresponding to the touch region, and
wherein the one optical sensor unit or the number of individual optical sensors automatically calculate a position of the human body or object touching a specific point at a predetermined position displayed on the display panel, based on the database of the host and automatically compensate the touch region of the display panel, to automatically correct the position.

2. A touch panel by optics unit sensor, comprising:
an image inputting step (S10) in which one optical sensor unit or a number of individual optical sensors arranged around an edge part or on a diagonal line of a display panel inputs an image of a human body or object approaching to a touch region of the display panel;
a security sensor's sensing and inputting step (S20) in which a security sensor, which is provided to correctly determine whether the human body or object approached to the touch region of the display panel have touched, senses and input whether touched or not to provide a sensed data;
an image data processing step (S30) in which an image processor processes the image being input in the image inputting step (S10) and converts the image into an image data signal;
an image data signal converting step (S40) in which the image data signal obtained in the image data processing step (S30) is converted into a digital signal recognizable for a controller and the digital signal is transmitted to the controller;
a position setting and correcting step (S50) in which the controller calculates a focus distance of the human body or object positioned at the touch panel region of the display panel and corrects the position, based on the digital signal data sent in the image data signal converting step (S40);
a security sensor's data processing step (S60) in which the sensed data is processed to distinguish whether the human body or object touches the touch panel region of the display panel, based on the sensed data being input in the security sensor's sensing and inputting step (S20);
a position data outputting step (S70) in which a coordinate value calculated in the security sensor's data processing step (S60) and the position setting and correcting step (S50) is transmitted to a host such as PC or the like by communication; and
a cursor driving and display panel outputting step (S80) in which the host receives the coordinate value being input in the position data outputting step (S70), loads a corresponding program, and displays data being processed by a database included in the program on the display panel.

3. The touch panel according to claim 1, further comprising: a security sensor in the display panel.

4. The touch panel according to claim 3, wherein the security sensor is any one of an infrared sensor, an ultrasonic wave sensor, a capacitive type sensor, a resistive type sensor and a piezoelectric type senor.

5. The touch panel according to claim 1, wherein the optical sensor unit or individual optical sensor is a CCD (charge-coupled device) image sensor or a CMOS (complementary metal oxide semiconductor).

6. The touch panel according to claim 2, wherein the optical sensor unit or individual optical sensor is a CCD (charge-coupled device) image sensor or a CMOS (complementary metal oxide semiconductor).
